(19) United States
(12) Patent Application Publication
(10) Pub. No.: US 2014/0171844 A1
(43) Pub. Date: Jun. 19, 2014

(54) Mobile Water/ Aquatic Therapy Vehicle Equipped with Hot Tub for Various Water Physical Therapy Provided Door-to-Door At Residential/Patient Home/Nursing Home or Other Living/NonLiving Facility- A New Way of Doing Business and Providing Therapy

(71) Applicant: Lolita Richmond, Willoughby, OH (US)

(72) Inventor: Lolita Richmond, Willoughby, OH (US)

(21) Appl. No.: 13/713,656

(22) Filed: Dec. 13, 2012

(51) Int. Cl. A61H 33/00

(52) U.S. Cl. CPC A61H 33/0087
USPC 601/154

(57) ABSTRACT

The Mobile Water Therapy Vehicle Equipped with Hot Tub for Various Water Physical Therapy Provided Door To Door At Home, Nursing Home or Other Living, Non-Living Facility is a truck fitted with a hot tub with multiple jets designed to provide water therapy with a walk-in and wheel chair accessible ramp and hot tub pool for the patient, nurse and physical therapist to assist the patient with water therapy. The unit is equipped with a hydraulic chair lift system allowing patients with limited ambulatory ability to be placed in the hot tub unit. The mobile water therapy is designed to assist patients with a variety of medical and physical challenges. The unit is designed for individuals with and without limited mobility. The mobile water therapy vehicle provides a new way of doing business by bringing water therapy to patients.

### SPECIFICATION/TECHNICAL FIELD OF THE INVENTION

The present invention relates to a mobile unit, a mobile vehicle equipped with a hot tub for the purpose of providing water therapy to individuals in need of periodic water therapy for a variety of medical conditions which range from arthritis to post surgical therapy to chronic muscle or other medical infirmities. The unit is designed for the medical benefit of patients and consumers but could be utilized for the purpose of convenience.

### BACKGROUND OF THE INVENTION

Currently patients requiring or prescribed water therapy must seek such treatment at a local YMCA or health spa or fitness facility. These establishments require memberships, which are often cost prohibitive for patients within specific demographics such as senior citizens and low income. Moreover for some patients the treatment may only be needed for a limited amount of time and not worth the investment of an extended membership.

### BRIEF DESCRIPTION (SUMMARY) OF THE INVENTION

Water therapy is commonly recommended by physicians for a variety of medical reasons ranging from common and chronic arthritis to rehabilitation following surgery and injuries to complex and terminal muscle problems. Based upon a patient's physical limitations getting to a traditional facility could be challenging. Many traditional facilities have limited lifeguard hours and limitations on the staff and hydraulic or other means of getting patients in a pool or hot tub for water therapy. This invention combines the ability for a patient to receive the necessary therapy as well as the means to assist them with getting in the hot tub unit. Because the hot tub unit has many jets there is the ability to allow the patient to manipulate many needed therapeutic areas in the hot tub. The unit also contains a massage chair to further assist with therapy. The unit will be staffed with medical personnel able to properly assist the patient to safely get in and out of the hot tub. The hot tub will be a state of the art unit, which will be maintained with clean water and the appropriate chemicals to maintain the sanitation of the unit. The hot tub will be self contained in the truck and not removed for the purpose of providing therapy. This is a mobile water therapeutic treatment.

### BRIEF DESCRIPTION OF THE DRAWINGS

FIG. 1B is an interior elevation (plan) view of The Mobile Water/Aquatic Therapy Vehicle Equipped with Hot Tub for Various Water Physical Therapy Provided Door-To-Door At Residential/Patient Home/Nursing Home or Other Living/Non-Living Facility, displaying interior components of the vehicle including the hot tub of FIG. 1, according to the invention. The structure, operation, and advantages of the presently preferred embodiment of the invention will become further apparent upon consideration of the following description taken in conjunction with the accompanying drawings, wherein:

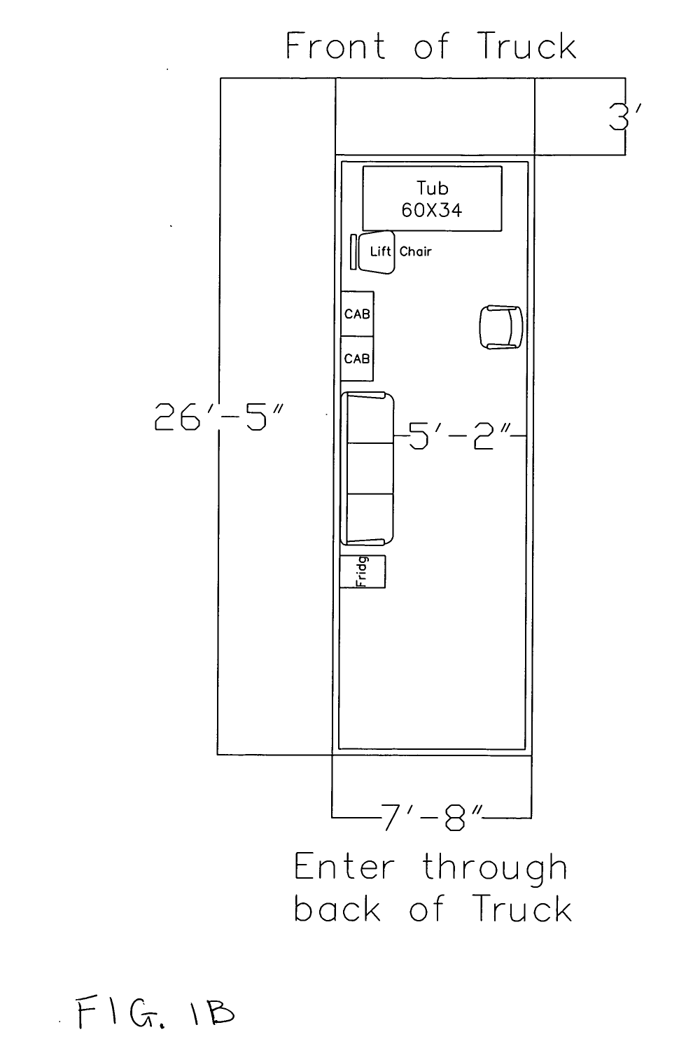

1-12. (canceled)

13. An approximate 26-foot truck with rear ramp for wheel chair and walking entrance specially fitted hot tub with multiple water jets designed to provide water therapy for various extremities equipped with a hydraulic chair lift system including safety straps allowing patients with limited ambulatory ability to be placed in the hot tub unit within the truck.

2. The vehicle will have the ability to drive to the patient's home or nursing home driveway/parking lot to provide mobile water physical therapy services for up to 20-30 minutes or less depending on physician orders.

3. The mobile water therapy is designed to assist patients with a variety of physical and medical conditions who can benefit from water therapy providing a new way of doing business for the medical community and their patients.
